(19) United States
(12) Patent Application Publication
(10) Pub. No.: US 2024/0090088 A1
(43) Pub. Date: Mar. 14, 2024

(54) HEATING ASSEMBLY AND ELECTROTHERMAL FURNACE

(71) Applicant: Guangdong willing Technology Corporation, Guangdong (CN)

(72) Inventors: JINGNONG YE, Guangdong (CN); SHIFA LUO, Guangdong (CN)

(73) Assignee: Guangdong willing Technology Corporation, Guangdong (CN)

(21) Appl. No.: 17/987,856

(22) Filed: Nov. 15, 2022

(30) Foreign Application Priority Data
Sep. 9, 2022 (CN) 202222399739.7

(51) Int. Cl. H05B 3/26; H05B 3/08; H05B 3/14

(52) U.S. Cl. CPC H05B 3/265; H05B 3/08; H05B 3/141; H05B 2203/033

(57) ABSTRACT

A heating assembly, comprising a base plate, the base plate being provided with a plurality of ceramic heating sheets, the ceramic heating sheets being spaced apart side by side and being connected in parallel, and a heat conduction structure being provided over the ceramic heating sheets. An electrothermal furnace having the heating assembly is also provided.

### CROSS-REFERENCE TO RELATED APPLICATION

This application claims the priority benefit of China application serial no. 202222399739.7, filed on Sep. 9, 2022. The entirety of the above-mentioned patent application is hereby incorporated by reference herein and made a part of this specification.

### BACKGROUND

### Technical Field

The disclosure relates to the field of heating electrical appliances, in particular to a heating assembly and an electrothermal furnace.

### Description of Related Art

Household heating appliances without open flames include induction cookers, electrothermal furnaces, and some other household appliances such as electric ovens, electric cooking pots, etc. Induction cooker is an electrical appliance that uses electromagnetic induction to heat. The temperature of the heating panel of an induction cooker will not change much during being used. As for electric appliances such as electrothermal furnaces, electric ovens, and electric cooking pots, a heating assembly disposed in them and the heat generated by the heating assembly is transferred to components such as pans or baking trays or pots to heat and cook food materials.

Existing heating appliances that use heating assemblies generally use resistance wires. The resistance wires emit a certain amount of heat after being energized to heat. During heating, the microcrystalline panel is heated so that its temperature increases and becomes a conductor. When the distance between the resistance wires and the microcrystalline panel is relatively close, high voltage breakdown may occur. Therefore, in order to avoid this situation and ensure that the products meet the safety requirements, in the prior art, a certain distance (generally about 20 mm) is set between the resistance wires and the microcrystalline panel to ensure the safety during use.

### SUMMARY

Based on this, it is necessary to provide a heating assembly and an electrothermal furnace to solve the problems in the prior art.

A heating assembly comprising a base plate, the base plate being provided with a plurality of ceramic heating sheets which are spaced apart side by side, the ceramic heating sheets being connected in parallel, and a heat conduction structure being provided over the ceramic heating sheets.

In one embodiment, the base plate is provided with a recess, and the ceramic heating sheets are disposed at a position corresponding to the recess of the base plate, with a gap formed between the ceramic heating sheets and a bottom of the recess of the base plate.

In one embodiment, a side wall of the recess of the base plate is provided with holes, and the ceramic heating sheets are connected to the base plate through the holes.

In one embodiment, the recess of the base plate is provided with a heat insulating wool pad, and the heat insulating wool pad is located under the ceramic heating sheets.

In one embodiment, a heat insulating plate is provided under the base plate, the heat insulating plate is provided with an accommodating recess adapted to the base plate, and the base plate is disposed in the accommodating recess.

In one embodiment, the heating assembly further comprises a temperature sensor, and the temperature sensor is disposed under the heat conduction structure for detecting a temperature of the heat conduction structure.

The above heating assembly uses use ceramic heating sheets which have good insulation performance. Even if the ceramic heating sheets are attached to the heat conduction structure (microcrystalline panel), the breakdown phenomenon will not occur due to the increase of temperature of the heat conduction structure during use. Therefore, the safety of the product can be ensured during use. Due to the small distance between the ceramic heating sheets and the heat conduction structure, the heating efficiency of the ceramic heating sheets can be effectively improved, and the overall thickness of the heating assembly can be reduced.

An electrothermal furnace using the heating assembly above mentioned.

In one embodiment, the electrothermal furnace further comprises a casing, an upper side of the casing is provided with an opening, the heating assembly is disposed in the casing, and the heat conduction structure of the heating assembly is in contact with an outside at the opening.

In one embodiment, a thermochromic ring is provided at the opening of the casing, the thermochromic ring is in contact with the heat conduction structure, and the thermochromic ring is a metal ring coated with a thermochromic ink.

In one embodiment, a power socket is provided on one side of the casing, the power socket is provided with three connection terminals which are in a straight line, an adapted power cord is provided outside the power socket, one end of the power cord is provided with a power plug which can be inserted into the power socket, the power plug is provided with three terminal holes corresponding to the three connection terminals, and the three terminal holes are in the straight line.

For above electrothermal furnace, since the distance between the ceramic heating sheet and the microcrystalline panel can be set to be small, the overall thickness of the heating assembly will also be small, and the thickness of the electrothermal furnace using the heating assembly will also be small, thus obtaining a thin electrothermal furnace.

### BRIEF DESCRIPTION OF THE DRAWINGS

FIG. 1 is a schematic diagram of an overall structure of an electrothermal furnace according to the present disclosure.

FIG. 2 is an explosive view of the electrothermal furnace according to the present disclosure.

FIG. 3 is an explosive view of a heating assembly according to the present disclosure;

FIG. 4 is a section view of the heating assembly according to the present disclosure.

FIG. 5 is a structural schematic diagram of a power socket and a power plug according to the present disclosure.

### DESCRIPTION OF THE EMBODIMENTS

In order to make the above objects, features and advantages of the present disclosure more obvious and easy to understand, the specific embodiments of the present disclosure will be described in detail below with reference to the accompanying drawings. In the following description, numerous specific details are set forth in order to provide a thorough understanding of the present disclosure. However, the present disclosure can be implemented in many other ways different from those described herein, and those skilled in the art can make similar improvements without departing from the connotation of the present disclosure. Therefore, the present disclosure is not limited by the specific embodiments disclosed below.

It should be noted that when an element is referred to as being “fixed to” another element, it can be directly on the other element or intervening elements may also be present. When an element is referred to as being “connected” to another element, it can be directly connected to the other element or intervening elements may also be present. In contrast, when an element is referred to as being “directly on” another element, there are no intervening elements present. The terms “vertical,” “horizontal,” “left,” “right,” and similar expressions are used herein for illustrative purposes only.”

Unless otherwise defined, all technical and scientific terms used herein have the same meaning as commonly understood by one of ordinary skill in the art to which this disclosure belongs. The terms used herein in the description of the present disclosure are for the purpose of describing specific embodiments only, and are not intended to limit the present disclosure. As used herein, the term “and/or” includes any and all combinations of one or more of the associated listed items.

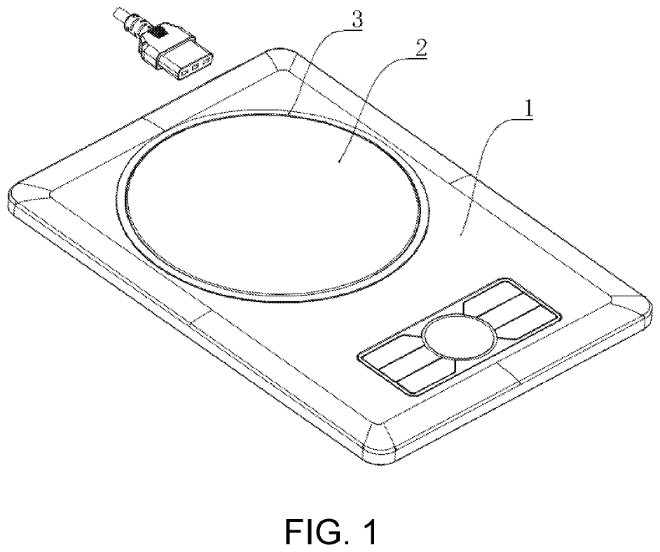

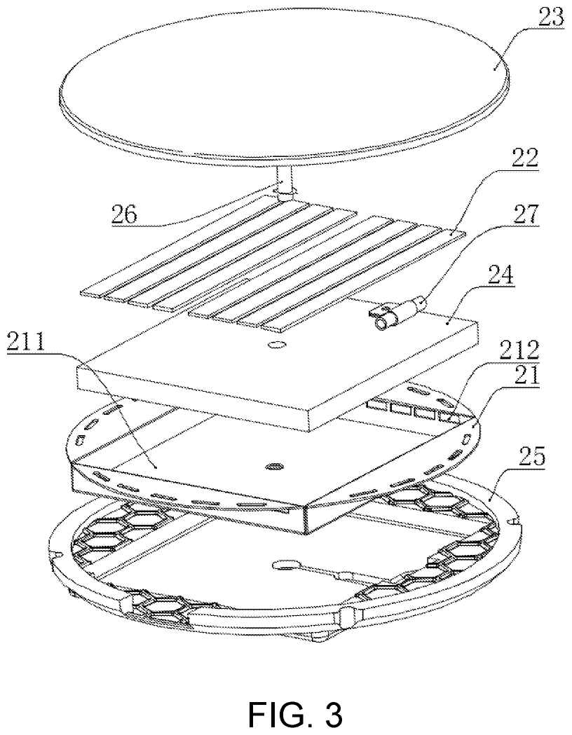

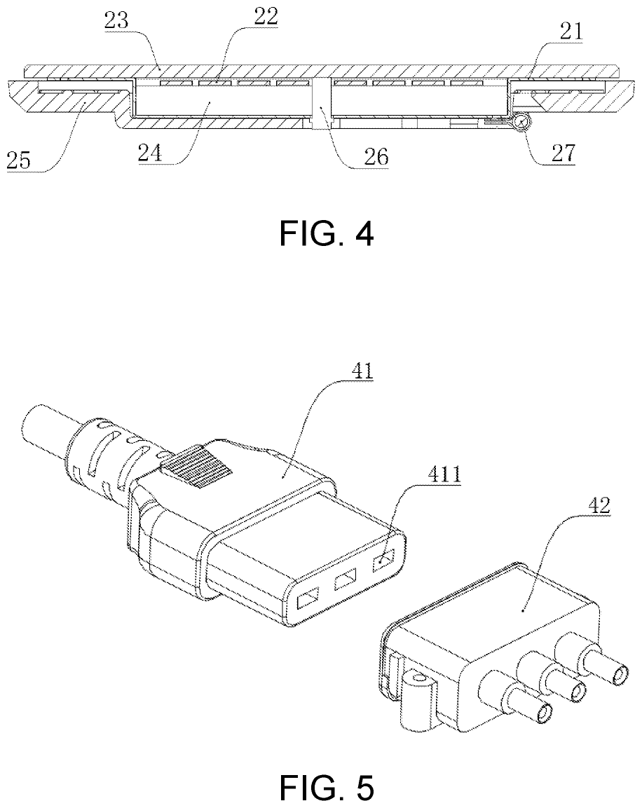

As shown in FIG. 3 and FIG. 4, a heating assembly 2 (FIG. 1) includes a base plate 21. The base plate 21 is provided with a plurality of ceramic heating sheets 22 which are spaced apart side by side. The heat conduction structure 23 is provided on the upper side of the ceramic heating sheet 22. The ceramic heating sheets 22 are connected in parallel and the heat conduction structure 23 is provided over the ceramic heating sheets 22.

The heating assembly uses ceramic heating sheets which have good insulation performance. Even if the ceramic heating sheets are attached to the heat conduction structure (microcrystalline panel), the breakdown phenomenon will not occur due to the increase of temperature of the heat conduction structure during use. Therefore, the safety of the heating assembly can be ensured during use. Due to the small distance between the ceramic heating sheets and the heat conduction structure, the heating efficiency of the ceramic heating sheets can be effectively improved, and the overall thickness of the heating assembly can be reduced.

Here, if resistance wires are used as heating elements, in order to ensure safety during use, the distance between the resistance wires and the heat conduction structure (microcrystalline panel) is about 20 mm. Therefore, the overall thickness of the electrothermal furnace using resistance wires will be thicker. However, in case of using ceramic heating sheets, the upper side of the ceramic heating sheets can be attached to the lower side of the microcrystalline panel, or a small distance therebetween (such as 1 mm, 5 mm, etc.) is available. During using the resulting heating assembly, the breakdown will not occur due to the good insulation performance of the ceramic heating assembly. This ensures safety during use, and products using such heating assembly can meet safety requirements, too.

Furthermore, the ceramic heating sheets 22 are spaced apart side by side to form a heating area. In this case, because the ceramic heating sheets 22 are connected in parallel, even if some ceramic heating sheets 22 cannot function normally during use, the heating assembly 2 can also have a heating effect.

In this embodiment, in order to prevent the heat emitted from the lower side of the ceramic heating sheets 22 from being transferred to the base plate 21, and then transferred to the bottom case of the product through the base plate 21, thereby causing a problem that the temperature of the bottom case is too high, the base plate 21 is provided with a recess 211, and the ceramic heating sheet 22 is disposed at a position corresponding to the recess 211 of the base plate 21, with a gap formed between the ceramic heating sheet 22 and the bottom of the recess 211 of the base plate 21. Here, by setting the recess 211 on the base plate 21, and then disposing the ceramic heating sheets 22 at the position corresponding to the recess 211 of the base plate 21, there is a gap between the ceramic heating sheet 22 and the base plate 21, which reduces the heat transferred to the base plate 21 and the bottom case.

The ceramic heating sheets 22 are fixed to the base plate 21. In this embodiment, holes 212 are provided in the sides of the recess 211 of the base plate 21, and the ceramic heating sheets 22 are connected to the base plate 21 at the holes 212. Holes 212 are provided in two opposite sides of the recess 211 of the base plate 21. Then each ceramic heating sheet 22 is penetrated from one of the holes 212 in one side and then extends across the recess 211 of the base plate 21 and finally passes through the opposite hole 212 on the other side of the base plate 21, so that the ceramic heating sheet 22 is fixed at the position of the hole 212 of the base plate 21. Here, the height of the ceramic heating sheet 22 on the base plate 21 can be determined by controlling the height of the hole 212. By means of the holes 212 on the sides of the base plate 21, the ceramic heating sheets 22 can be easily and quickly installed steadily on the base plate 21.

In order to further reduce the heat transferred from the ceramic heating sheets 22 to the lower side of the base plate 21 and the bottom case, in this embodiment, the recess 211 of the base plate 21 is provided with a heat insulating wool pad 24. The heat insulating wool pad 24 is located under the ceramic heating sheets 22, and the added heat insulating wool pad 24 can enhance the heat insulation effect. Here, the heat insulating wool pad 24 is disposed at the position of the recess 211, and the size of the heat insulating wool pad 24 is adapted to the recess 211. When placed in the recess 211 which has a limit function, the heat insulating wool pad 24 will not move in the recess 211. After disposing the heat insulating wool pad 24 in the recess 211, the ceramic heating sheets 22 are located over the insulation wool pad 24.

To further prevent heat being transferred downward, in this embodiment, a heat insulating plate 25 is provided under the base plate 21. The heat insulating plate 25 is provided with an accommodating recess adapted to the base plate 21, and the base plate 21 is disposed in the accommodating recess. Here, the heat insulating plate 25 is located at the lower side of the base plate 21 to cover the base plate 21 completely, so as to further reduce the heat transfer to the bottom case.

After passing through the heat insulating wool pad 24, the heat insulating plate 25 and the base plate 21, the heat transferred downward from the ceramic heating sheets 22 can be effectively reduced. After adopting this structure, the temperature at the bottom of the resulting heating assembly 2 is low. When applied to the related product, the distance between the bottom of the heating assembly 2 and the bottom case of the product can be reduced, so that a thin product can be formed.

In this embodiment, in order to ensure safety during use in case of the heating assembly 2 being adopted, the heating assembly 2 further includes a temperature sensor 26. The temperature sensor 26 is disposed under the heat conduction structure 23 for detecting the temperature of the heat conduction structure 23. In this embodiment, a thermocouple is used for the temperature sensor 26 to detect the temperature of the heat conduction structure 23. Meanwhile, in this embodiment, a thermal fuse 27 is also provided to cut off the power when the temperature is abnormal, so as to ensure safety when using the product.

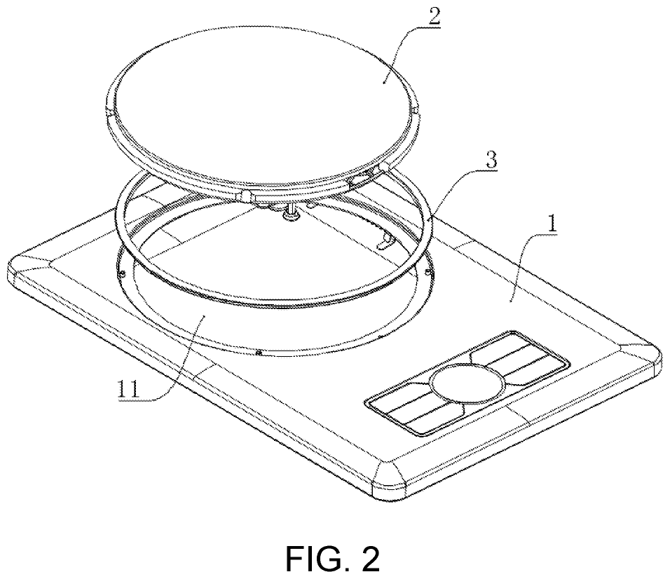

As shown in FIG. 1 to FIG. 5, an electrothermal furnace uses the above-mentioned heating assembly 2, the electrothermal furnace further includes a casing 1, an opening 11 is provided in the upper side of the casing 1. The heating assembly 2 is disposed in the casing 1, and the heat conduction structure 23 of the heating assembly 2 is in contact with the outside at the opening 11.

Since the distance between the ceramic heating assembly used and the microcrystalline panel can be set to be small, the overall thickness of the heating assembly will be small, so that the thickness of the electrothermal furnace using the heating assembly will also be small, thereby obtaining a thin electrothermal furnace.

Here, the opening 11 is disposed on the upper side of the casing 1, and then the heat conduction structure 23 of the heating assembly 2 is disposed at the position of the opening 11. The heat conduction structure 23 is fixed at the position of the opening 11 on the upper side of the casing 1. Here, the heat conduction structure 23 is a microcrystalline panel, and the casing 1 can be made of different materials according to actual needs, such as stainless steel. Here, the upper side of the housing 1 is provided with an opening 11, the heat conduction structure 23 of the heating assembly 23 is provided at the position of the opening 11. In this way, the ceramic heating sheet 22 of the heating assembly 2 is located at a position under the opening 11, and the heat conduction structure 23 of the heating assembly 2 is directly in contact with the outside at the position of the opening 11 of the casing 1. During use, a pot body is directly placed on the upper side of the heat conduction structure 23, which is convenient for users to use, and at the same time, will not affect the heat transfer so as to improve the heating efficiency.

Here, since the heating is achieved by heat transfer, the temperature of the microcrystalline panel is bound to be high. Therefore, in order to avoid being scalded by touching the microcrystalline panel after use, in this embodiment, the position of the opening 11 the housing 1 is provided with a thermochromic ring 3. The thermochromic ring 3 is in contact with the heat conduction structure 23, and the thermochromic ring 3 is a metal ring coated with thermochromic ink. The thermochromic ring 3 is sleeved at the outer position of the microcrystalline panel. During the use, the temperature of the micro-crystalline panel increases. Through heat transfer, the temperature of the thermochromic ring 3 will also increase. The ring 3 is coated with thermochromic ink, so the color of the thermochromic ring 3 changes to remind the user of the temperature of the microcrystalline panel, so as to prevent the user from directly touching the microcrystalline panel after use.

By using the heating assembly 2, since the overall thickness of the heating assembly 2 is relatively small, the overall thickness of the electrothermal furnace can be reduced. In order to avoid the thickness of the electric furnace increases due to the power plug and socket, in the present embodiment, as shown in FIG. 1 and FIG. 5, one side of the housing 1 is provided with a power socket 41, the power socket 41 is provided with three connection terminals in a straight line, and the outer side of the power socket 41 is provided with a adaptable power cord. One end of the power cord is provided with a power plug 42 which can be inserted into the power socket 41, and the power plug 42 is provided with three terminal holes 411 in the straight line corresponding to the connection terminals. Here, the connection terminals are in the straight line, and the corresponding terminal holes 411 are in the straight line too. By disposing the connection terminals in a straight line rather than disposing in a triangle in the prior art, the heights of the power plug 42 and the power socket 41 can be effectively reduced, which can thus be applied to the electrothermal furnace in this embodiment to form a thin electrothermal furnace.

After setting the wiring terminals in a straight line, in order to avoid potential safety hazards, the width of the power plugs 42 can be appropriately increased, thereby increasing the distance between the adjacent plug terminals. Although this will increase the width of the power plug 42, it has little effect on height. Therefore, it can be applied to thin electrothermal furnaces.

Here, in order to avoid the power plug 42 being inserted in a wrong direction, a ground terminal is set in the middle position, and a live line and a neutral line are located on the two sides of the ground terminal, respectively. In this way, there is no need to pay attention to the up and down of the power plug 42 during use, hence “blind insertion” can be realized. Of course, foolproof protruding structures can also be provided on the power plug 42 and the power socket 41 to ensure that the power plug 42 can only be inserted in one direction, so as to avoid connection errors of the plug-in terminals.

The technical features of the above-described embodiments can be combined arbitrarily. For the sake of brevity, all possible combinations of the technical features in the above-described embodiments are not described. However, as long as there is no contradiction between the combinations of these technical features, all the combinations should be regarded as the scope described in this specification.

The above-mentioned embodiments only represent several embodiments of the present disclosure, and the descriptions thereof are specific and detailed, but should not be construed as a limitation on the scope of the disclosure patent. It should be pointed out that for those of ordinary skill in the art, without departing from the concept of the present disclosure, several modifications and improvements can also be made, which all belong to the protection scope of the present disclosure. Therefore, the protection scope of the patent of the present disclosure should be subject to the appended claims.

What is claimed is:

1. A heating assembly, comprising a base plate, the base plate being provided with a plurality of ceramic heating sheets, the ceramic heating sheets being spaced apart side by side being connected in parallel, and a heat conduction structure being provided over the ceramic heating sheets.

2. The heating assembly according to claim 1, wherein the base plate is provided with a recess, and the ceramic heating sheets are disposed at a position corresponding to the recess of the base plate, with a gap formed between the ceramic heating sheets and a bottom of the recess of the base plate.

3. The heating assembly according to claim 2, wherein a side wall of the recess of the base plate is provided with holes, and the ceramic heating sheets are connected to the base plate through the holes.

4. The heating assembly according to claim 3, wherein the recess of the base plate is provided with a heat insulating wool pad, and the heat insulating wool pad is located under the ceramic heating sheets.

5. The heating assembly according to claim 3, wherein, a heat insulating plate is provided under the base plate, the heat insulating plate is provided with an accommodating recess adapted to the base plate, and the base plate is disposed in the accommodating recess.

6. The heating assembly according to claim 3, wherein the heating assembly further comprises a temperature sensor, and the temperature sensor is disposed under the heat conduction structure for detecting a temperature of the heat conduction structure.

7. An electrothermal furnace using the heating assembly according to claim 1.

8. The electrothermal furnace according to claim 7, wherein the electrothermal furnace further comprises a casing, an upper side of the casing is provided with an opening, the heating assembly is disposed in the casing, and the heat conduction structure of the heating assembly is in contact with an outside at the opening.

9. The electrothermal furnace according to claim 8, wherein a thermochromic ring is provided at the opening of the casing, the thermochromic ring is in contact with the heat conduction structure, and the thermochromic ring is a metal ring coated with a thermochromic ink.

10. The electrothermal furnace according to claim 7, wherein a power socket is provided on one side of the casing, the power socket is provided with three connection terminals, three connection terminals are in a straight line, an adapted power cord is provided outside the power socket, one end of the adapted power cord is provided with a power plug, the power plug is adapted to be inserted into the power socket, the power plug is provided with three terminal holes corresponding to the three connection terminals, and the three terminal holes are in the straight line.
